(19) United States
(12) Patent Application Publication
(10) Pub. No.: US 2012/0296601 A1
(43) Pub. Date: Nov. 22, 2012

(54) Method and apparatus for monitoring motion of a substatially rigid

(76) Inventor: Graham Paul Eatwell, Annapolis, MD (US)

(21) Appl. No.: 13/506,766

(22) Filed: May 16, 2012

Related U.S. Application Data
(60) Provisional application No. 61/519,354, filed on May 20, 2011.

(51) Int. Cl. G01P 1/00; G06F 15/00

(52) U.S. Cl. 702/141; 73/493

(57) ABSTRACT

A method and apparatus for monitoring motion of a substantially rigid body relative to at a first location, in which linear and rotational motions are sensed by one or more motion sensors attached to the substantially rigid body at other locations. The sensed rotation is used to compensate for the angular and centripetal acceleration components in the sensed linear motion. In one embodiment, the components are estimated explicitly from the sensed rotation. In a further embodiment, the sensed rotations are used to estimate the relative orientations of two or more sensors, enabling the linear motions to be combined so as to cancel the angular and centripetal accelerations. A reference sensor may be used for in-situ calibration. When the substantially rigid body is a human head, the reference sensor may be coupled to a helmet or mouthguard.

### PRIORITY CLAIM

This application claims priority from Provisional Application Ser. No. 61/519,354, filed May 20, 2011, titled “Method and Apparatus for Monitoring Rigid Body Motion in a Selected Frame of Reference”, which is hereby incorporated herein.

### BACKGROUND

A variety of methods have been proposed to measure head impacts. One approach uses sensors in a helmet. This approach is flawed since the helmet may rotate on the head during an impact, or even become displaced.

Another approach uses tri-axial accelerometers embedded in patches attached to the head. This approach is has limited accuracy since the position and orientation of the patches on head is not known precisely.

Yet another approach uses a combination of a tri-axial linear accelerometer and a gyroscope. This approach yields rotations and linear acceleration at the sensor location. However, when the desire is to measure the motion of a rigid body, such as a human head, it is often impossible or impractical to place a sensor at the center of the rigid body.

### BRIEF DESCRIPTION OF THE FIGURES

The accompanying figures, in which like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a diagrammatic representation of a system for monitoring acceleration of a rigid body in accordance with certain embodiments of the present invention.

FIG. 2 is a block diagram of a system for monitoring rigid body motion using a single six degree-of-freedom in accordance with certain embodiments of the present invention.

FIG. 3 is a flow chart of a method for monitoring motion of a rigid body, using a six degree of freedom sensor, in accordance with certain embodiments of the present invention.

FIG. 4 is a block diagram of a system for monitoring rigid body motion using two six-degree-of-freedom sensors, in accordance with certain embodiments of the invention.

FIG. 5 is a flow chart of a method for monitoring rigid body motion using two six-degree-freedom sensors, in accordance with certain embodiments of the invention.

FIG. 6A and FIG. 6B are views of an exemplary sensor, in accordance with certain embodiments of the invention.

FIG. 7 is a diagrammatic representation of a system for monitoring head motion in accordance with certain embodiments of the invention.

FIG. 8 is a further diagrammatic representation of a system for monitoring head motion in accordance with certain embodiments of the invention.

FIG. 9 is a flow chart of a method for monitoring rigid body motion using self-calibration, in accordance with certain embodiments of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to monitoring motion of a substantially rigid body, such as a head. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

It will be appreciated that embodiments of the invention described herein may include the use of one or more conventional processors and unique stored program instructions that control the one or more processors to implement, in conjunction with certain non-processor circuits, some, most, or all of the functions of monitoring head accelerations described herein. The non-processor circuits may include, but are not limited to, a radio receiver, a radio transmitter, signal drivers, clock circuits, power source circuits, and user input devices. As such, these functions may be interpreted as a method to monitor head accelerations. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of the present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

The present disclosure relates to a method and apparatus for monitoring motion of a rigid body, such as a human head, relative to a first location. Linear and rotational motions are sensed by one or more sensors attached to the rigid body at locations displaced from the first location. The sensed rotation is used to compensate for the angular and centripetal acceleration components in the sensed linear motion. In one embodiment, the angular and centripetal acceleration components are estimated explicitly from the sensed rotation. In a further embodiment, the sensed rotations are used to estimate the relative orientations of two or more sensors, enabling the linear motions measured by the two sensors to be combined so as to cancel the angular and centripetal accelerations.

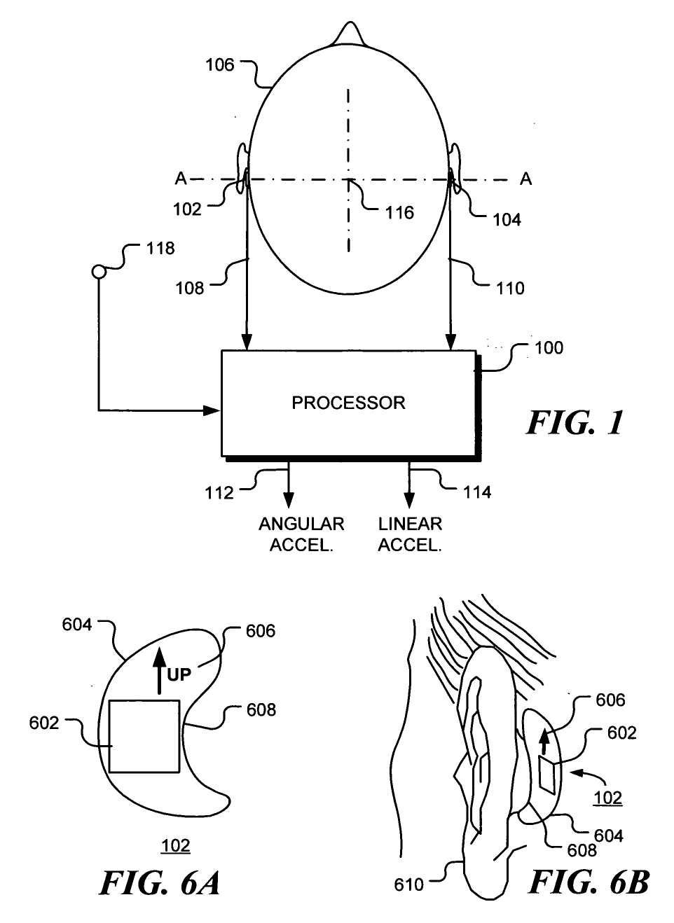

FIG. 1 is a diagrammatic representation of a system for monitoring acceleration of a substantially rigid body in accordance with certain embodiments of the present invention. The system comprises a processor 100 that receives signals from a first motion sensor 102. In some embodiments, the processor 100 also receives signals from a second motion sensor 104. The first and second motion sensors may be configured to measure both linear and rotational motions and may be six degree-of-freedom sensors. In operation, the first and second sensors 102 and 104 are located on a substantially rigid body 106, such as human head, and are coupled to the processor 100 via wired or wireless connections 108 and 110, respectively. The processor 100 may be integrated with one of the sensors, located in proximity to a sensor (such as attached to a helmet, mouthguard, or belt pack), or placed at a location remote to the sensor. While shown diagrammatically as a head in FIG. 1, the present invention has application to other rigid bodies. For example, the rigid body could be a helmet, a handheld device, an instrument or tool, or a vehicle.

In one embodiment, a six degree-of-freedom sensor comprises a three-axis linear motion sensor, such as a tri-axial accelerometer that senses local linear motion, and a rotational sensor that measures three components of a rotational motion. The rotational sensor maybe, for example, a three-axis gyroscope that senses angular velocity, or a three-axis rotational accelerometer that senses the rate of change of angular velocity with time, or a three axis angular displacement sensors such as a compass, or a combination thereof. The six degree-of freedom sensor may comprise more than six sensing elements. For example, both rotational rate and rotational acceleration could be sensed (or even rotational position). These signals are not independent, since they are related through their time histories. However, having both types of sensors may avoid the need for integration or differentiation.

The processor 100 receives the sensor signals 108 and 110 and from them generates angular acceleration signals 112 and linear acceleration signals 114 in a frame of reference that does not have its origin at a sensor position and may not have its axes aligned with the axes of the sensor.

In one embodiment, which uses two sensors, the origin of the frame of reference is at a midpoint of the line A-A between the sensors 102 and 104, denoted in FIG. 1 by the point labeled 116.

In a further embodiment, which uses a single sensor, the origin may be selected to be any point whose position is known relative to the single sensor.

In the selected frame of reference, the vector of angular velocities of the substantially rigid body is denoted as ω, the angular acceleration vector is denoted as \dot{ω}, and the linear acceleration vector is denoted as a.

It is noted that the angular acceleration may be obtained from angular velocity by differentiation with respect to time and, conversely, the angular velocity may be obtained from the angular acceleration by integration with respect to time. These integrations or differentiations may be performed using an analog circuit, a sampled data circuit or by digital signal processing. Thus, either type of rotation sensor could be used. Alternatively, or in addition, a rotation displacement sensor, such as a magnetic field sensor, may be used. Angular velocity and angular acceleration may then be obtained by single and double differentiation, respectively.

The response s of a linear accelerometer at a position r={r₁, r₂, r₃}^{T} in the selected frame of reference is given by

s=Sₗᵢₙ[a+(K(\dot{ω})+K²(ω))r]=Sₗᵢₙ[a−K(r)\dot{ω}+P(r)γ(ω)], (1)

where a is the linear acceleration vector at the origin of the frame of reference and γ(ω) is a vector of centripetal accelerations given by

$$γ ( ω ) = [ \begin{matrix}- {ω}_{1}^{2} - {ω}_{2}^{2} \\ - {ω}_{2}^{2} - {ω}_{3}^{2} \\ - {ω}_{3}^{2} - {ω}_{1}^{2} \\ {ω}_{1} {ω}_{2} \\ {ω}_{2} {ω}_{3} \\ {ω}_{3} {ω}_{1}\end{matrix} ] . \qquad ( 2 )$$

Sₗᵢₙ is the linear sensitivity matrix for the sensor (which is dependent upon the sensor orientation), the matrix function K is defined as the skew symmetric matrix given by

$$K ( r ) {=}^{Δ} [ \begin{matrix}0 & - {r}_{3} & {r}_{2} \\ {r}_{3} & 0 & - {r}_{1} \\ - {r}_{2} & {r}_{1} & 0\end{matrix} ] , \qquad ( 3 )$$

the matrix P is given by

$$P ( r ) {=}^{Δ} [ \begin{matrix}0 & {r}_{1} & 0 & {r}_{2} & 0 & {r}_{3} \\ 0 & 0 & {r}_{2} & {r}_{1} & {r}_{3} & 0 \\ {r}_{3} & 0 & 0 & 0 & {r}_{2} & {r}_{1}\end{matrix} ] \qquad ( 4 )$$

In general, for a rotational sensor, the response vector is

w=Sᵣₒₜ(ω,\dot{ω}), (5)

where Sᵣₒₜ is the angular sensitivity matrix of the sensor. From this we can get (using integration or differentiation as required)

ω=F(w),

\dot{ω}=G(w) (6)

where F and G are functions that depend upon the angular sensitivity matrix Sᵣₒₜ of the sensor.

In accordance with a first aspect of the disclosure, the linear acceleration at the origin of the frame of reference may be derived from the sensed linear and rotation motion.

Rearranging equation (1) gives

a=Sₗᵢₙ⁻¹s+K(r)\dot{ω}−P(r)γ(ω), (7)

and estimating the rotational components from the rotation sensor signal w gives

a=Sₗᵢₙ⁻¹s+K(r)G(w)−P(r)γ(F(w)), (8a)

or,

a=Sₗᵢₙ⁻¹s−[K(G(w))+K²(F(w))]r, (8b)

Thus, the linear acceleration at the origin is obtained as a combination of the linear motion s, and rotational motion w sensed at the sensor location, the combination being dependent upon the position r of the sensor relative to the origin and the linear sensitivity and orientation of the sensor through the matrix Sₗᵢₙ. The matrix parameters K(r) and P(r) used in the combination (8a) are dependent upon the position r.

For a rigid body, the rotational acceleration at the origin is the same as the rotational acceleration at the sensor location and is given by equation (6).

It is noted that the combination defined in equations (8a) and (8b) requires knowledge of the sensitivities of the sensor and knowledge of position of the sensor relative to the origin.

In equation (7), the matrix Sₗᵢₙ is dependent upon the orientation of the sensor relative to the frame of reference.

In one embodiment the sensor is oriented in a known way on the rigid body. This is facilitated by marking the sensor (for example with an arrow).

In a further embodiment, the sensor is shaped to facilitate consistent positioning and/orientation on the body. For example, a behind-the-ear sensor may be shaped to conform to the profile of an ear, or a nose sensor is shaped to conform to the bridge of the nose.

In a still further embodiment, a measurement of the sensor orientation relative to the direction of gravity is made and the frame of reference is fixed relative to the direction of gravity.

Generic System

In a still further embodiment, measurement of the sensor orientation relative to a reference sensor, shown as 118 in FIG. 1, is made and the frame of reference is fixed relative to the reference sensor. The reference sensor 118 may be, for example, a three-axis linear accelerometer that measures the gravitation vector when there is no rotation present, or a three-axis rotation sensor, such as a gyroscope or rotational accelerometer, or a combination thereof. Multiple sensors may be used. Alignment is discussed in more detail below, with reference to equations (14)-(16). In one embodiment, in which the rigid body is a human head, the one or more reference sensors are attached with a known orientation, and at a known position, to a reference structure, such as helmet to be worn on the head or to a mouthpiece or mouthguard. For low acceleration movements, the reference structure moves with the head and provides consistent orientation with respect to the head. A sensor, such as a position, proximity, pressure or light sensor for example, may be used to detect when the reference structure is in position. This allows the sensor 102 to be placed on the head in any orientation. In general, the one or more reference sensors may be attached to a reference structure that, at least at low acceleration levels, moves with the rigid body to be measured.

A sensor may be attached using self-adhesive tape, for example. The sensor should be as light as possible, so that the resonance frequency of the sensor mass on the compliance of the skin is as high as possible (see, for example, ‘A Triaxial Accelerometer and Portable Data Processing Unit for the Assessment of Daily Physical Activity’, Carlijn V. C. Bouten et al., IEEE TRANSACTIONS ON BIOMEDICAL ENGINEERING, VOL. 44, NO. 3, MARCH 1997, page 145, column 2, and references therein). A self adhesive, battery powered sensor may be used, the battery being activated when the sensor is attached to the head.

The sensor 102 may be calibrated with respect to the reference sensor 118.

Single Sensor

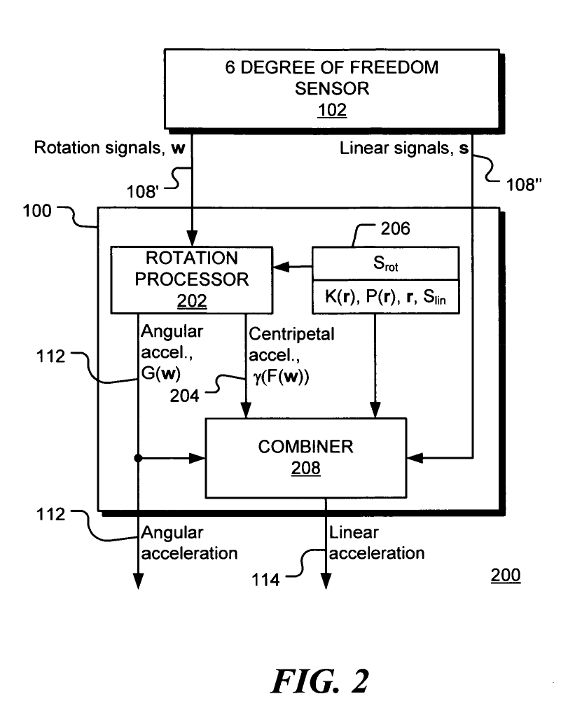

FIG. 2 is a block diagram of a system 200 for monitoring head motion, helmet motion, or other rigid body motion, using a single six degree-of-freedom sensor 102. The processor 100 receives rotational motion signals 108′, denoted as w, and linear motion signals 108″, denoted as s, from the six degree-of-freedom sensor 102. The rotational motion signals 108′ are processed in a rotation processor 202 to produce angular acceleration signals 112, denoted as \dot{ω}=G (w), and centripetal acceleration signals 204, denoted as γ(ω)=γ(F(ω)) (defined in equation (2) above). Operation of the rotation processor 202 is dependent upon the sensor's rotational sensitivity matrix Sᵣₒₜ stored in a memory 206. The linear motion signals 108″, angular acceleration signals 112 and centripetal acceleration signals 204 are combined in combiner 208 in accordance with equation (8) above, using matrix coefficients stored in a memory 206, to produce the linear acceleration signals 114. The linear acceleration signals 114 are referenced to selected origin, rather than the sensor position. The matrix coefficients stored in the memory 206 are dependent upon the position of the sensor relative to the selected origin. The linear acceleration signals 114 are output from the system. Optionally, the rotational acceleration and/or centripetal acceleration may be output.

The system 200 enables monitoring motion of a substantially rigid body relative to a first location in response to linear 108″ and rotational motion signals 108′ from a motion sensor 102 locatable on the substantially rigid body at a second location, displaced from the first location. The system comprises a processing module 202 responsive to the rotational motion signal 108′ and operable to produce a plurality of rotational components, 112 and 204. A memory 206 stores parameters dependent upon the first and second locations. A combiner 208 combines the plurality of rotational components with the linear motion signals 108″, dependent upon the parameters stored in the memory 206, to provide an estimate of the motion at the first location in the substantially rigid body. The signals 114 and/or 112, representative of the motion at the first location, are provided as outputs. The rotational components comprise first rotational components 112, dependent upon angular acceleration of the substantially rigid body and second rotational components 204 dependent upon angular velocity of the substantially rigid body.

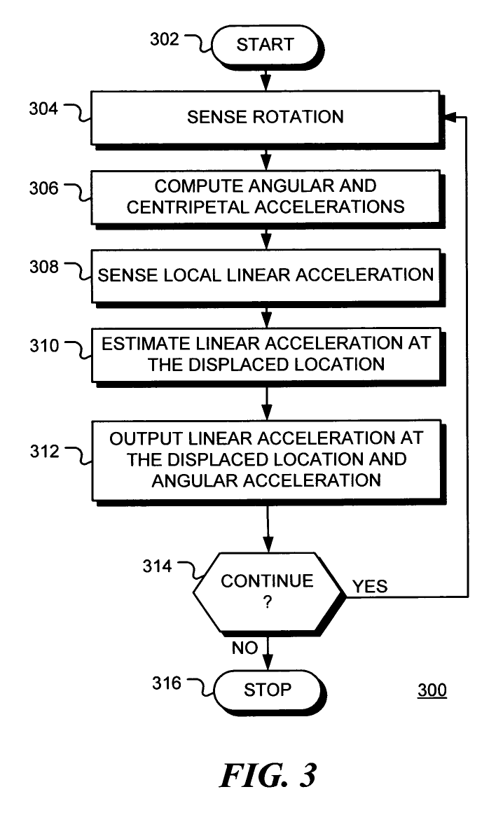

FIG. 3 is a flow chart 300 of a method for monitoring motion of a rigid body, such as a human head, using a six degree of freedom sensor. Following start block 302 in FIG. 3, rotation of the rigid body is sensed at block 304. At block 306, the angular and centripetal accelerations are computed from the sensed signals in accordance with equation (6) above. At block 308, the local linear accelerations (at the sensor position) are sensed. At block 310, the linear accelerations at another location, displaced from the sensor location are estimated by combining the local linear acceleration signals with the angular and centripetal acceleration signals in accordance with equation (8). At block 312, the signal representing the linear accelerations at the displaced location is output. The signals may be output via a wired or wireless connection to a remote location, a proximal location, or a local storage device. Optionally, the angular acceleration and/or centripetal accelerations may also be output. If, as depicted by the positive branch from decision block 314, continued monitoring of motion is required, flow returns to block 304. Otherwise, the method terminates at block 316.

The flow chart in FIG. 3 shows an illustrative embodiment of a method for monitoring motion of a substantially rigid body relative to a first location. The method comprises sensing a linear acceleration vector of the substantially rigid body at a second location, displaced from the first location, sensing a first rotation of the substantially rigid body, determining an angular acceleration component of the sensed linear acceleration vector from the sensed first rotation, determining a centripetal acceleration component of the sensed linear acceleration vector from the sensed first rotation, estimating the linear motion at the first location dependent upon a combination of the angular acceleration component, the centripetal acceleration component and the linear acceleration vector, and outputting a signal representative of the motion at the first location. The combination is dependent upon the relative positions of the first and second locations.

While the approach described above has the advantage of using a single sensor, one disadvantage o is that, unless a reference sensor is used, the approach requires knowledge of position of the sensor relative to the origin. However, if a reference sensor is used, the position, orientation and sensitivity may be estimated.

Two or More Sensors

In accordance with a second aspect of the present disclosure, the linear acceleration at the origin of the frame of reference may be derived from the sensed linear and rotation motion at two or more sensors. In one embodiment, two sensors are used, located on opposite sides of the desired monitoring position. For example, one sensor could be either side of a head to monitor motion relative to a location between the sensors. This approach avoids the need to know the sensor locations relative to the selected origin, and also avoids the need for differentiation or integration with respect to time, although more than one sensor is required.

To facilitate explanation, a two-sensor system is considered first. The first and second sensors are referred to as ‘left’ and ‘right’ sensors, however, it is to be understood that any pair of sensors may be used.

The origin is defined as the midpoint between the two sensors. Thus, the sensor positions are r_{L}={r₁, r₂, r₃}^{T} for the left sensor and r_{R}={−r₁, −r₂, −r₃}^{T} for the right sensor.

The accelerations are not necessarily the same, since, as discussed above, each measurement is in the frame of reference of the corresponding sensor. In the frame of reference of the left sensor,

S_{L,lin}⁻¹s_{L}=a+[K(\dot{ω})+K²(ω)]r_{L}, (9)

R⁻¹S_{R,lin}⁻¹s_{R}=a+[K(\dot{ω})+K²(ω)]r_{R}, (10)

where R is a rotation matrix that is determined by the relative orientations of the two sensors and the sensitivity matrices are relative to the sensor's own frame of reference. R⁻¹S_{R,lin}⁻¹s_{R} is a vector of compensated and aligned right sensor signals and S_{L,lin}⁻¹s_{L} is the vector of compensated left sensor signals.

Averaging (9) and (10) gives

½S_{L,lin}⁻¹s_{L}+½R⁻¹S_{R,lin}⁻¹s_{R}=a+½[K(\dot{ω})+K²(ω)](r_{L}+r_{R})=a (11)

where R is a rotation matrix that is determined by the relative orientations of the two sensors and the sensitivity matrices are relative to the sensor's own frame of reference. Here we have used r_{L}+r_{R}=0.

This allows the linear acceleration at the origin (the midpoint) to be estimated as the simple combination

$$a = \frac{1}{2} {S}_{L , lin}^{- 1} {s}_{L} + \frac{1}{2} {R}^{- 1} {S}_{R , lin}^{- 1} {s}_{R} . \qquad ( 12 )$$

In some applications, the left and right sensors may be orientated with sufficient accuracy that the rotation matrix can be assumed to be known. In other applications, the rotation matrix R may be estimated from a number of rotation measurements (rate or acceleration). The measurements may be collected as

W_{R}=RW_{L}, (13)

where W_{L} and W_{R} are signal matrices given by

W_{R}=[W_{R,1}W_{R,2} . . . w_{R,N}], (14)

W_{L}=[W_{L,1}W_{L,2} . . . w_{L,N}].

This equation may be solved by any of a variety of techniques known to those of ordinary skill in the art. For example, an unconstrained least squares solution is given by

R=W_{R}W_{L}^{T}(W_{L}W_{L}^{T})⁻¹. (15)

The solution may be constrained such that R is a pure rotation matrix.

Alternatively, the rotation matrix may be found from the rotational motion signals using an iterative algorithm, such as least mean square or recursive least mean square algorithm.

The relative orientation may also be obtained by comparing gravitation vectors, provided that the body is not rotating.

More generally, a weighted average of the aligned signals from two or more sensors (adjusted for orientation and sensitivity) may be use to estimate the linear acceleration at a position given by a corresponding weighted average of the sensor positions when the sum of the weights is equal to one. If a is the linear motion at the position

$$\overline{r} {=}^{Δ} {\sum }_{i} {α}_{i} {r}_{i} , with {\sum }_{i} {α}_{i} = 1 ,$$

the weighted average of aligned signals is

$$\begin{matrix}{\sum }_{i} {α}_{i} {R}_{i}^{T} {S}_{i}^{- 1} {s}_{i} = {\sum }_{i} {α}_{i} a + [ K ( \dot{ω} ) + {K}^{2} ( ω ) ] {\sum }_{i} {α}_{i} ( {r}_{i} - \overline{r} ) \\ = a + [ K ( \dot{ω} ) + {K}^{2} ( ω ) ] ( {\sum }_{i} {α}_{i} {r}_{i} - \overline{r} ) \\ = a\end{matrix} , \qquad ( 16 )$$

where Rᵢ is the alignment matrix for sensor i, αᵢ are weights that sum to unity, and Sᵢ is a sensitivity matrix. The vector rᵢ−ē denotes the position vector from the position r̅ to sensor i.

Equation (16) is a generalization of equation (12) and describes operation of a system for monitoring motion of a substantially rigid body relative to a first location, r̅. In operation, a plurality of motion sensors are located on the substantially rigid body at a plurality of second locations, rᵢ, displaced from the first location r̅, each motion sensor (with index i) of the plurality of motion sensors operable to measure a motion vector sᵢ at a second location rᵢ of the plurality of second locations. A processing module includes an alignment estimator operable to produce an alignment matrix Rᵢ between each motion sensor of the plurality of motion sensors and a reference frame, dependent upon the motion vectors at the plurality of second locations. An alignment module aligns the motion vectors with the frame of reference, using the alignment matrix, to produce a plurality of aligned motion vectors, RᵢSᵢ⁻¹sᵢ. A combiner combines the plurality of aligned motion vectors to provide an estimate

$${\sum }_{i} {α}_{i} {R}_{i} {S}_{i}^{- 1} {s}_{i}$$

of the motion at the first location in the substantially rigid body. A signal representative of the motion of the substantially rigid body relative to the first location is output or saved n a memory.

The position vector r̅ of the first location is a weighted average

$${\sum }_{i} {α}_{i} {r}_{i}$$

of the position vectors of the plurality of second locations and the estimate of the motion at the first location comprises a corresponding weighted average

$${\sum }_{i} {α}_{i} {R}_{i} {S}_{i}^{- 1} {s}_{i}$$

of the plurality of aligned motion vectors.

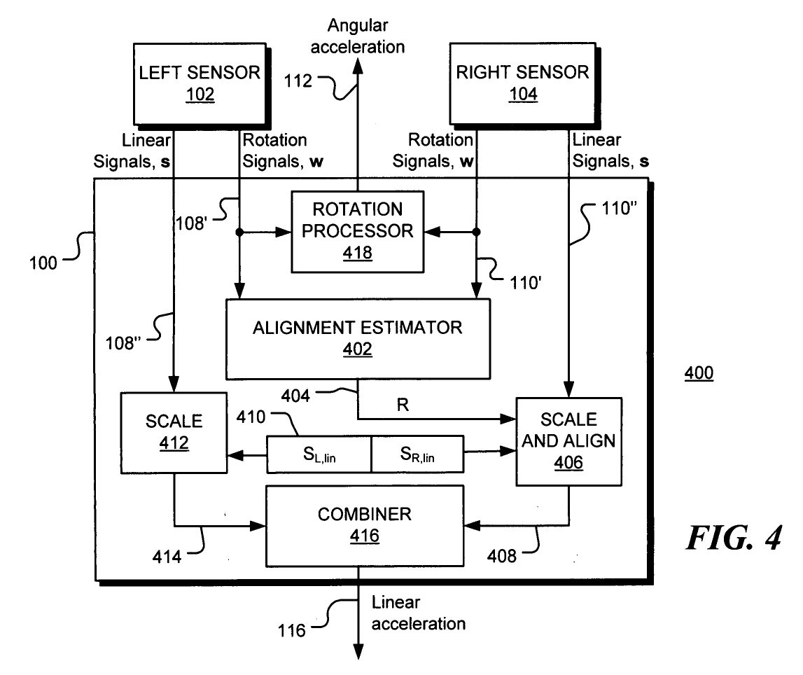

FIG. 4 is a block diagram of a system 400 for monitoring rigid body motion using two six degree-of-freedom sensors in accordance with certain embodiments of the disclosure. Referring to FIG. 4, a left sensor 102 provides rotational motion signals 108′ and linear motion signals 108″ to a processor 100 and a right sensor 104 provides rotational motion signals 110′ and linear motion signals 110″ to the processor 100. The rotational motion signals 108′ and 110′ are fed to alignment estimator 402. From these signals, the alignment estimator 402 determines a rotation matrix 404, denoted as R, which describes the relative orientations of the left and right sensors. The alignment estimator 402 solves equation (13). In one embodiment, it implements equation (15), or a similar algorithm, such as an iterative least squares algorithm, a constrained least squares algorithm or a singular value decomposition algorithm. A variety of such algorithms are known to those of ordinary skill in the art. The rotation matrix 404 is used in a scaling and alignment module 406 to compensate for the right sensor sensitivity and align the linear motion signals of the right sensor with the linear motion signals of the left sensor. The scaling and alignment module 406 produces compensated and aligned linear motion signals, R⁻¹S_{R,lin}⁻¹s_{R}, 408 from the right sensor as output. The scaling and alignment module 406 utilizes the linear sensitivity matrix S_{R,lin} of the left sensor, which is stored in a memory 410. Scaling module 412 scales the left sensor linear motion signals to compensate for the sensitivity of the left sensor, dependent upon the linear sensitivity matrix S_{L,lin} of the left sensor, and produces compensated left sensor linear motion signals, S_{L,lin}⁻¹s_{L}, 414. The compensated and aligned linear motion signals 408 from the right sensor are combined with the compensated linear motion signals 414 from the left sensor in combiner 416, in accordance with equation (12) or equation (16), to produce an estimate 116 of the linear acceleration at the origin (the midpoint). The estimate 116 of the linear acceleration at the origin is output for local storage or transmission to a remote location. Optionally, the rotational motion signals 108′ and 110′ are processed in rotation processor 418 to produce an estimate 112 of the angular acceleration. In one embodiment, the rotational motion signals are scaled dependent upon the rotational sensitivity matrices, S_{L,rot} and S_{R,rot}, aligned, and then averaged to produce the estimate 112. The signals are differentiated with respect to time if they correspond to angular velocity rather than angular acceleration.

Measurements of the motion at the two sensors may be synchronized by means of a synchronization signal, such as a clock with an encoded synchronization pulse. The clock may be generated by the processor 100 or by one of the sensors. When identical sensors are used, a ‘handshake’ procedure may be use to establish which sensor will operate at the master and which will operate as the slave. Such procedures are well known to those of ordinary skill in the art, particularly in the field of wired and wireless communications.

The signals 112 and 116 together describe the motion of the rigid body and may be used to determine, for example, the direction and strength of an impact to the body. This has application to the monitoring of head impacts to predict brain injury.

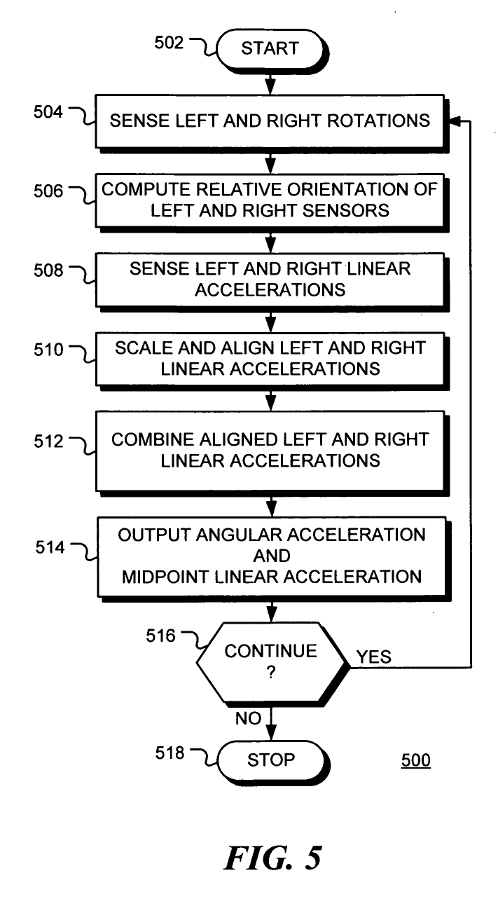

FIG. 5 is a flow chart 500 of method for monitoring rigid body motion using two six degree-of-freedom sensors in accordance with certain embodiments of the disclosure. Following start block 502 in FIG. 5, the rotational motions at the left and right sensors are sensed at block 504. The rotational motion signals are used, at block 506, to compute a rotation matrix that describes the relative orientations of the left and right sensors. At block 508, the left and right linear accelerations are sensed. At block 510, the sensed linear acceleration signals are scaled and aligned using the sensitivity matrices and the rotation matrix. The scaled and aligned linear acceleration signals are combined at block 512 to produce an estimate of the linear acceleration vector at the midpoint between the left and right sensors. At block 514, the estimate of the linear acceleration vector is output. Optionally, the angular acceleration vector is also output at block 514. If monitoring is to be continued, as depicted by the positive branch from decision block 516, flow returns either to block 504 to update the estimate of the relative orientations, or to block 508 to continue sensing the linear accelerations. Otherwise, as depicted by the negative branch from decision block 516, the process terminates at block 518.

In a still further embodiment, the alignment matrix R is found by comparing measurements of the gravity vector made at each sensor location. These measurements may be made by the linear elements of sensor or by integrated gravity sensors. In this embodiment one of the sensors does not require rotational sensing elements, although such elements may be included for convenience or to improve the accuracy of the rotation measurement.

In one embodiment the sensor is oriented in a known way on the rigid body. This is facilitated by marking the sensor (for example with an arrow).

Consistent positioning and orientation of the sensors may be facilitated by shaping or marking the sensor. For example, a behind-the-ear sensor may be shaped to conform to the profile of the back of an ear, or a nose sensor shaped to conform to the bridge of the nose. FIG. 6A shows an exemplary sensor 102 adapted for positioning behind an ear. The sensor includes a sensing circuit 602, a patch or other mounting structure 604 for attaching the sensor to the head and a marker 606 for indicating the correct orientation. In this example, the marker comprises an arrow and lettering that indicate the UP direction. In the example shown, the edge 608 of the patch or mounting structure 604 has a concave edge shape to match the shape of the back of the ear. FIG. 6B shows the sensor positioned behind an ear 610. In a further embodiment, the patch is configured for positioning behind either ear. A measurement of the direction of gravity may be used to determine if the sensor is on the left or right side of the head.

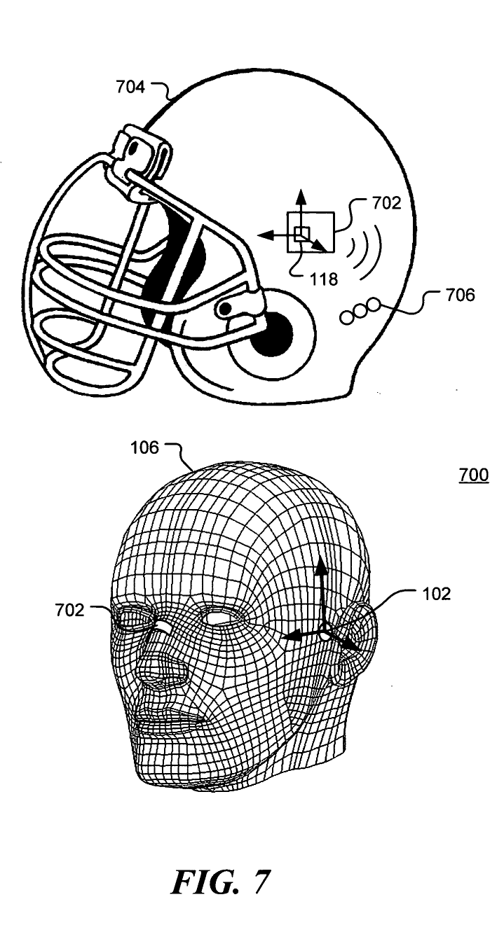

More generally, the sensor elements are coupled to a mounting structure shaped for consistent orientation with respect to a characteristic feature of a substantially rigid body, and outputs linear and rotational motion signals. In a further embodiment, the mounting structure comprises a flexible band, such as 702 shown in FIG. 7, for configured for alignment with the bridge of a nose.

Self Calibration

In a further embodiment of the invention, the head mounted sensing system is calibrated with relative to a reference sensing system on a helmet, mouthguard or other reference structure. The position of the helmet on a head is relatively consistent. The positioning of mouthguard, such as protective mouth guard is very consistent, especially if custom molded to the wearer's teeth. While both a helmet and a mouthguard can be dislodged following an impact, they move with the head for low level linear and rotational accelerations. The calibration is not simple since there is a non-linear relationship between the sensor signals due to the presence of centripetal accelerations. The method has application to head motion monitoring, for sports players and military personnel for example, but also has other applications. For example, the relative positions and orientations of two rigid objects that are coupled together, at least for a while, may be determined from sensors on the two bodies.

Self calibration avoids the need to position and orient sensor accurately on the head and also avoids the need to calibrate the head sensors for sensitivity. This reduces the cost of the head sensors. A unique identifier may be associated with each helmet or mouthguard. This avoids the need for have a unique identifier associated with each head sensor, again reducing cost. Also, signals transmitted to a remote location (such as the edge of a sports field) are more easily associated with an individual person whose head is being monitored. That is, the helmet or mouthguard may be registered as belonging to a particular person, rather than registering each head sensor. Additionally, the helmet or mouthguard sensor may be used as a backup should the head sensor fail and may also detect such failure.

FIG. 7 is a diagrammatic representation of a system 700 for monitoring head motion in accordance with certain embodiments of the invention. The system 700 comprises a sensor 102, such as a six degree-of-freedom sensor, adapted to be attached to a head 106.

The system 700 also comprises a reference sensor 118 of a reference sensing system 702 coupled to a helmet 704. The reference sensing system 702 may also include a processor, a transmitter and a receiver. A helmet 704 is shown in FIG. 7, but other reference structures, such as a mouthguard, may be used. The reference sensor 118 may comprise a rotational sensor such as a three-axis gyroscope or three-axis rotational accelerometer. The reference sensor may also include a three-axis linear accelerometer. In the embodiment shown, the sensor is operable to establish a wireless connection to the processing module 100 mounted in the helmet. The helmet may include a sensor to detect when the helmet 704 is in the correct position on the head 106.

In operation, the processing module 100 operates to compute a rotation matrix R that describes the relative orientation of the head mounted sensor 102 relative to the helmet mounted sensor 118. The rotation matrix satisfies

W_{H}=S_{H,rot}RS_{R,rot}⁻¹W_{R}, (17)

where if I_{L} and W_{R} are signal matrices given by

W_{R}=[ω_{R,1}ω_{R,2} . . . ω_{R,N}],

W_{H}=[ω_{H,1}ω_{H,2} . . . ω_{H,N}], (18)

The subscript ‘R’ denotes the reference sensor and the subscript ‘H’ denotes the head mounted sensor. Since the inverse sensitivity matrix S_{R,rot}⁻¹ of the reference sensor is known, equation (17) may be solved in the processing module for the matrix product S_{H,rot}R, the inverse of which is used to compute rotations relative to the frame of reference of the reference sensor. The matrix product may be estimated when the reference structure is first coupled to the head, or it may be continuously updated during operation whenever the rotations are below a threshold. Higher level rotations are not used, since they may cause the helmet to rotate relative to the head.

When a linear reference sensor is used, the gravitation vectors measured by the reference and head mounted sensors may be used to estimate the rotation matrix. The rotation matrix satisfies

G_{H}=S_{H,lin}RS_{R,lin}⁻¹G_{R}, (19)

where G_{L} and G_{R} are matrices of gravity vectors given by

G_{R}=[g_{R,1}g_{R,2} . . . g_{R,N}],

G_{H}=[g_{H,1}g_{H,2} . . . g_{H,N}]. (20)

The gravity vectors are measured during periods where the head is stationary. Equation (19) may be solved for the matrix product S_{H,lin}R.

The acceleration at the head mounted sensor may be written as

s_{H}=S_{H,lin}R[a−K(r_{RH})\dot{ω}+P(r_{RH})γ(ω)], (22)

where a is the acceleration vector at the reference sensor. Since the rotation vectors are known (from the head mounted sensor and/or the reference sensor) equation (22) may be solved in the processing module to estimate the position vector r_{RH} of the head mounted sensor relative to the reference sensor. Additionally, if the position center of the head is known relative to the reference sensor on the helmet, the position of the head mounted sensor may be found relative to center of the head.

The orientation can be found from the rotational components. If the linear and rotation sensing elements are in a known alignment with one another, the orientation of the linear sensing elements can also be found. Once the orientation is known, either predetermined or measured, the sensitivity and positions of the linear elements can be found. The output from a sensing element is related to the rigid body motion {a, \dot{ω}, ω} by

sᵢ=gᵢ⁻¹ηᵢ^{T}[a+K(\dot{ω})rᵢ+K₂(ω)rᵢ], (23)

where ηᵢ^{T} is the orientation and gᵢ⁻¹ is the sensitivity. In matrix format, the relationship may be written as

$$[ \begin{matrix}{s}_{i} & - {η}_{i}^{T} \{ K ( \dot{ω} ) + {K}^{2} ( ω ) \}\end{matrix} ] [ \begin{matrix}{g}_{i} \\ {r}_{i}\end{matrix} ] = {η}_{i}^{T} a . \qquad ( 24 )$$

An ensemble averaging over a number of sample points provides as estimate of the inverse sensitivity of the sensing element and the position of the sensing element as

$$[ \begin{matrix}{g}_{i} \\ r\end{matrix} ] = {〈 {A}^{T} A 〉}^{- 1} 〈 {A}^{T} {η}_{i}^{T} a 〉 , \qquad ( 25 )$$

where the matrix A is given by

A=[sᵢ−ηᵢ^{T}{K(\dot{ω})+K²(ω)}]. (26)

Thus, the position and sensitivity of the sensing element may be determined from the sensor output s, and the measured rotation, once the orientation is known.

The sensor orientation may be determined (a) by assumption (b) from gravity measurements (c) from rotation measurement and/or (d) from rigid body motion measurements, for example. Once the orientation is known, the sensitivity and position may be determined from equations (25) and (26) above.

If several sensing elements are positioned at the same location, their positions may be estimated jointly. Equation (24) can be modified as

$$[ \begin{matrix}{s}_{1} & 0 & 0 & - {η}_{1}^{T} \{ K ( \dot{ω} ) + {K}^{2} ( ω ) \} \\ 0 & {s}_{2} & 0 & - {η}_{2}^{T} \{ K ( \dot{ω} ) + {K}^{2} ( ω ) \} \\ 0 & 0 & {s}_{3} & - {η}_{3}^{T} \{ K ( \dot{ω} ) + {K}^{2} ( ω ) \}\end{matrix} ] [ \begin{matrix}{g}_{1} \\ {g}_{2} \\ {g}_{3} \\ r\end{matrix} ] = [ \begin{matrix}{η}_{1}^{T} a \\ {η}_{2}^{T} a \\ {η}_{3}^{T} a\end{matrix} ] , \qquad ( 27 )$$

or, in matrix form,

$$\begin{matrix}[ \begin{matrix}diag ( s ) & - U \{ K ( \dot{ω} ) + {K}^{2} ( ω ) \}\end{matrix} ] [ \begin{matrix}g \\ r\end{matrix} ] = Ua & ( 28 ) \\ where U = [ \begin{matrix}{η}_{1}^{T} \\ {η}_{2}^{T} \\ {η}_{3}^{T}\end{matrix} ] . & \end{matrix}$$

Once calibrated, the acceleration at the origin (the center of the head for example) may be found using

a=[S_{H,lin}R]⁻¹s_{H}+K(r_{H})\dot{ω}−P(r_{H})γ(ω), (29)

where r_{H} is the position of the head mounted sensor relative to the origin. This computation uses the inverse of the matrix product S_{H,lin}R, so separation of the two matrices, while possible, is not required.

Thus, a reference sensor on the mounted on a reference structure, such as a helmet or mouthguard, may be used to determine the orientation and position of the head mounted sensor, together with its sensitivity. This is important for practical applications, such as monitoring head impacts during sports games or for military personnel, where accurate positioning of a head mounted sensor is impractical, and calibration of the head mounted sensors may be expensive.

The helmet 704 may support one or more visual indicators such as light emitting diodes (LEDs) 706 or different colors. These indicators may be used to show the system state. States could include, for example, ‘power on’, ‘head sensors found’, ‘calibrating’, ‘calibration complete’ and ‘impact detected’. In one embodiment, an impact above a threshold is indicated by a flashing red light, with the level of the impact indicated by the speed of flashing.

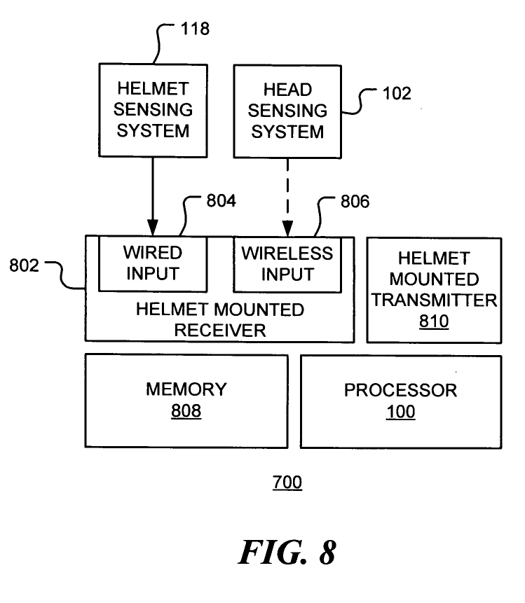

FIG. 8 is a further diagrammatic representation of the system 700 for monitoring head motion in accordance with certain embodiments of the invention. Referring to FIG. 8, the system 700 comprises a helmet motion sensing system 118, such a six degree-of-freedom sensor or a sensor array, operable to produce a first signal in response to motion of a helmet worn on the head, a receiver 802. The receiver 802 comprising a first input 804 operable to receive the first signal and a second input 806 operable to receive a second signal produced by a head motion sensing system 102 in response to motion of the head. The head motion sensing system 102 may comprise a six degree-of freedom sensor or an array of sensors. In one embodiment, the first input comprises a wired input and the second input comprises a wireless input. The system also includes a processor 100, either mounted in the helmet or at a remote location, which is operable to process the first and second signals to calibrate the head motion sensing system relative to the helmet motion sensing system and to process the second signals to determine head motion. The system may include a memory 808 for storing a description of the head motion or for storing the first and second signals, and a transmitter for transmitting a description of the head motion, and/or the first and second signals, to remote location. The transmitted signal may include an identifier that may be used to identify the helmet, and thus the wearer. While FIG. 8 refers to a helmet, an alternative reference structure, such as a mouthguard, may be used.

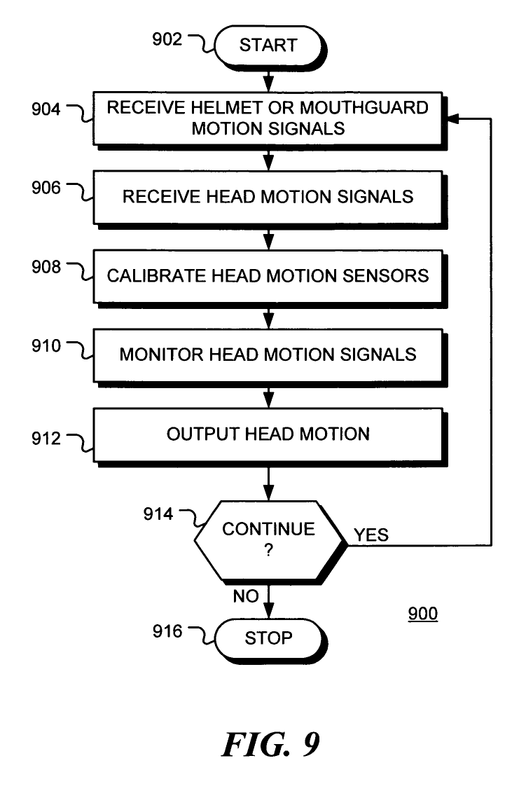

FIG. 9 is a flow chart 900 of method for monitoring rigid body motion using self-calibration, in accordance with certain embodiments of the invention. Following start block 902 in FIG. 9, reference motion signals are received at block 904 (from motion sensors on a helmet, mouthguard or other reference structure) and head motion signals are received at block 906 from head motion sensors. At block 908, the reference and head motion signals are processed to calibrate the head motion sensors relative to the reference structure motion sensors. The calibration parameters, such as sensor sensitivity, orientation and position, may be stored in a memory. At block 910, the head motion signals are monitored and combined with the calibration parameters to determine motion of the head. A description of the head motion is then output, at block 912, to a local memory to a remote location. If continued operation is required, as depicted by the positive branch from decision block 914, flow continues to block 904 to update the calibration parameters, or flow continues to block 910 to monitor head motion signals. Otherwise, the method terminates at block 916.

In one embodiment, the head motion is only calculated or output when motion is above a threshold level and calibration is only performed when the motion is below a threshold.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of the present invention. The benefits, advantages, solutions to problems, and any element(s) that may cause any benefit, advantage, or solution to occur or become more pronounced are not to be construed as a critical, required, or essential features or elements of the invention.

What is claimed is:

1. An apparatus for monitoring motion of a substantially rigid body, comprising:
a mounting structure shaped for consistent orientation with respect to a characteristic feature of the substantially rigid body;
a motion sensor operable to produce linear and rotational motion signals; and
an output operable to transmit the linear and rotational motion signals.

2. The apparatus of claim 1, where the substantially rigid body comprises a human head and where the mounting structure comprises a concave edge for alignment behind an ear.

3. The apparatus of claim 1, where the substantially rigid body comprises a human head and where the mounting structure comprises a band for alignment with the bridge of a nose.

4. The apparatus of claim 1, where the mounting structure is marked to facilitate consistent orientation on the substantially rigid body.

5. The apparatus of claim 1, where the motion sensor comprises a three-axis linear accelerometer and at least one sensor selected from the group of sensors comprising: a rotational displacement sensor, a gyroscope and a rotational accelerometer.

6. A system for monitoring motion of a substantially rigid body relative to a first location comprising:
a processing module responsive to sensed rotational motion of substantially rigid body, the processing module operable to produce a plurality of rotational components;
a memory for storing parameters dependent upon the first location and the second location;
a combiner operable to combine the plurality of rotational components with a linear motion sensed at a second location, displaced from the first location, dependent upon the parameters stored in the memory, to provide an estimate of the motion of the substantially rigid body relative to the first location; and
an output operable to output a signal representative of the motion relative to the first location.

7. A system in accordance with claim 6, where the plurality of rotational components comprise:
first rotational components, dependent upon angular acceleration of the substantially rigid body; and
second rotational components dependent upon angular velocity of the substantially rigid body.

8. A system in accordance with claim 6, further comprising a motion sensor, where the motion sensor is shaped for consistent orientation with respect to a characteristic feature of the substantially rigid body and is operable to sense the rotational motion and the linear motion at the second location.

9. A system in accordance with claim 6, further comprising:
a reference structure adapted to couple, at least part, to the motion of substantially rigid body; and
a reference sensing system coupled to the reference structure and configured to sense motion of the reference structure,
where the processing module is further operable to determine the orientation of a motion sensor at the second location dependent upon the signals from the reference sensing system and signals from the motion sensor located at the second location.

10. A system in accordance with claim 9, where the substantially rigid body comprises a human head, and where the reference structure is selected from the group of reference structures consisting of a helmet and a mouthguard.

11. A system in accordance with claim 9, where the reference sensing system comprises a three-axis rotational sensor and a three axis linear accelerometer.

12. A system in accordance with claim 9, where the reference sensing system further comprises a three-axis accelerometer and where the processing module is further operable to determine the parameters dependent upon the first location and the second location.

13. A system in accordance with claim 9, where the reference structure comprises a helmet and where the reference sensing system comprises at least six accelerometer elements positioned on the helmet to enable sensing of rigid body motion of the helmet.

14. A system for monitoring motion of a substantially rigid body relative to a first location comprising:
a plurality of motion sensors locatable on the substantially rigid body at a plurality of second locations, displaced from the first location, each motion sensor of the plurality of motion sensors operable to measure a motion vector at a second location of the plurality of second locations; and
a processing module comprising:
an alignment estimator operable to produce an alignment matrix between each motion sensor of the plurality of motion sensors and a reference frame, dependent upon the motion vectors at the plurality of second locations;
an alignment module operable to align the motion vectors with the frame of reference using the alignment matrix to produce a plurality of aligned motion vectors; and
a combiner operable to combine the plurality of aligned motion vectors to provide an estimate of the motion of the substantially rigid body relative to the first location; and
an output operable to output a signal representative of the motion of the substantially rigid body relative to the first location.

15. The system of claim 14, where the position vector of the first location is a weighted average of the position vectors of the plurality of second locations and where the estimate of the motion of the substantially rigid body relative to the first location comprises a corresponding weighted average of the plurality of aligned motion vectors.

16. The system of claim 14, where the alignment estimator is responsive to rotational motion sensed by the plurality of motion sensors.

17. The system of claim 14, where the plurality of motion sensors comprises a plurality of linear accelerometers and where the alignment estimator is responsive to gravity vectors sensed by the plurality of linear accelerometers.

18. A method for monitoring motion of a substantially rigid body relative to a first location comprising:
sensing a linear acceleration vector of the substantially rigid body at a second location, displaced from the first location;
sensing a first rotation of the substantially rigid body;
determining an angular acceleration component of the sensed linear acceleration vector from the sensed first rotation;
determining a centripetal acceleration component of the sensed linear acceleration vector from the sensed first rotation;
estimating the linear motion at the first location by combining the angular acceleration component, the centripetal acceleration component and the linear acceleration vector, the combination being dependent upon the relative positions of the first and second locations; and
outputting a signal representative of the motion of the substantially rigid body relative to the first location.

19. A method in accordance with claim 18, where sensing rotation of the substantially rigid body and sensing the linear acceleration vector at the second location comprises coupling a six degree-of-freedom sensor to the substantially rigid body at the second location.

20. A method in accordance with claim 19, further comprising:
coupling a reference sensor to motion of the substantially rigid body at a third location; and
determining an orientation of the six degree-of-freedom sensor relative to a frame of reference of the reference sensor,
where estimating the linear motion at the first location further comprises aligning the motion at the first location to the frame of reference of the reference sensor.

21. A method in accordance with claim 19, further comprising:
coupling a reference sensor to motion of the substantially rigid body at a third location; and
determining the second location relative to the third location dependent upon signals from the reference sensor and the six-degree-of-freedom sensor;
where estimating the linear motion at the first location is dependent upon the position of the second location relative to the third location.

22. A method in accordance with claim 18, where the substantially rigid body comprises a head and where coupling a reference sensor to the motion of the substantially rigid body at a third location comprises placing a helmet on the head, the reference sensor being coupled to the helmet.

23. A method in accordance with claim 18, where the substantially rigid body comprises a head and where coupling a reference sensor to the motion of the substantially rigid body at a third location comprises placing a mouthguard in the mouth of the head, the reference sensor being coupled to the mouthguard.

24. A method for monitoring motion of a substantially rigid body relative to a first location comprising:
coupling a first six degree-of-freedom sensor to the substantially rigid body to sense a motion vector at a second location;
coupling a second six degree-of-freedom sensor to the substantially rigid body to sense motion vector at a third location;
aligning the motion vector at the second location and motion vector at the third location to a common frame of reference to produce first and second aligned motion vectors; and
combining the first and second aligned motion vectors to produce a motion vector at the first location.

25. The method of claim 24, where the position vector of the first location comprises a weighted average of the position vectors of the first and second locations and where the motion vector of the substantially rigid body relative to the first location comprises a corresponding weighted average of the first and second aligned motion vectors.

26. The method of claim 24, where the substantially rigid body comprises a head and where the second and third locations are on opposite sides of the head.
